(19) United States
(12) Patent Application Publication
(10) Pub. No.: US 2004/0223631 A1
(43) Pub. Date: Nov. 11, 2004

(54) Face recognition based on obtaining two dimensional information from three-dimensional face shapes

(76) Inventors: Roman Waupotitsch, San Jose, CA (US); Arthur Zwern, San Jose, CA (US); Gerard Medioni, Los Angeles, CA (US)

Correspondence Address: FISH & RICHARDSON, PC, 12390 EL CAMINO REAL, SAN DIEGO, CA, 92130-2081, US

(21) Appl. No.: 10/434,481

(22) Filed: May 7, 2003

(51) Int. Cl. G06K 9/00

(52) U.S. Cl. 382/118

(57) ABSTRACT

A system of using three-dimensional information as a front and for a two-dimensional image comparison system. The three-dimensional information is obtained that is indicated of a known user's face. This three-dimensional information is used to generate two-dimensional views from different perspectives, including different poses and/or different lighting effects, and used to populate a database of a two-dimensional recognition system. The images are then two-dimensionally recognized using conventional two-dimensional recognition techniques, but this two-dimensional recognition is carried out on an improved database.

### BACKGROUND

A biometric is a measurement of any physical characteristic or personal trait of an individual that can be used to identify or verify the identity of that individual. Different forms of biometrics are well known and have been extensively tested. Common forms of biometrics include fingerprint, voice, eye scan (for example retinal scan and iris scan) face recognition, and others. Most biometric systems operate by initially enrolling individuals; that is collecting biometric samples from persons and using those samples to generate a template. The template is the data that represents the enrollee's biometric. The biometric system then matches new samples against the templates, and either verifies or identifies based on this matching.

Retinal scans and iris scans are extremely accurate, but may be considered intrusive by many people, since the scanner actually looks into the users eye. Moreover, the scan may require the user to cooperate, that is, it may require the user to look into the scanner in a certain way.

Fingerprint scans are also intrusive in that they require the user to put their hand into a fingerprint scanning device. In addition, the fingerprint scans often will not work on certain people who work with their hands (such as construction workers, and the like), and suffer from difficulties based on the actual orientation of the fingerprint. Moreover, if a user fails a fingerprint scan, there is no easy way to verify whether the user really should have failed that scan or not. Only highly trained individuals can manually match fingerprints. Finally, fingerprints require cooperation even more than retinal scans.

Face recognition has certain advantages in this regard. Initially, face recognition is not intrusive, since the face can be obtained by a simple camera, without requiring the user to do anything, other than walk by a location, and have their face captured by a camera. Similarly, face recognition does not require cooperation. Other face recognition systems may use lasers. While these latter techniques may be more intrusive, they are still no more intrusive than other technologies and do not require cooperation.

In addition, the human brain is extremely good at recognizing faces. An alarm allows a person to determine at a glance whether the face is correct or not.

The state-of-the-art in face recognition includes devices which are marketed by Viisage and Identix. These devices typically compare two-dimensional pictures of faces, against a two-dimensional template of another picture, which is stored in memory. The problem is that the comparison is intended to be a comparison of FACES, but the real comparison is a comparison of PICTURES OF FACES. Therefore, the comparison is highly affected by lighting, pose of the person, and other variances.

### SUMMARY

The present invention obtains three-dimensional data created from users' faces for biometric recognition and verification. According to an embodiment, the system acquires three dimensional information indicative of a user's face, e.g., a three-dimensional mask indicative of the shape of the face being imaged. This 3D information is then used to create two dimensional information which may be in the form of an image. The two dimensional information is used in a database of known faces as part of a biometric system.

The 2D images may be either an image which is formed from the 3D information which approximate characteristics of the “challenge” image, or simply a plurality of images having different typical characteristics, which are used to populate the database.

The two-dimensional information is then compared with information in the database, using conventional two-dimensional image comparing techniques. However, since the information in the database may include compensation for misrecognition parameters, such as lighting and pose, the comparison may be more accurate.

### BRIEF DESCRIPTION OF THE DRAWINGS

These and other aspects will now be described in detail with reference to the accompanying drawings, wherein:

FIG. 1 shows a block diagram of the hardware system; and

FIG. 2 shows a flowchart of the enrollment system.

### DETAILED DESCRIPTION

The present application teaches biometric operations based on faces.

Face recognition is well known. At least the following companies (Table I) are believed to be using face recognition for biometric applications.

| | Product | |
|---|---|---|
| Vendor | Availability | Technology |
| BioID | BioID | eienface/neural |
| | Client/Server | network: images |
| | | complied into single |
| | | reference face |
| Biometrica | Casino | eigenface |
| | Information | |
| | Network | |
| | Casino | |
| | Information | |
| | Database | |
| | Visual Casino | |
| | App. Suite | |
| Viisage | FacePASS, | eigenface |
| | Viisage | |
| | Gallery | |
| | (including | |
| | C++ DLL) | |
| Identix | FaceIt DB | local feature analysis |
| | FaceIt NT, | |
| | C++ SDK | |
| | Identification | |
| | and | |
| | Verification | |
| | SDK | |
| Imagis | ID 2000 | automatic face |
| | | processing |
| AcSys | HNeT Facial | Holographic/Quantum |
| | Recognition | Neural Technology |
| | System | |
| Ketware | FaceGuardian | local feature analysis |
| ZN Vision Technologies AG | Phantomas, | neural network |
| | ZN-Face | |
| Berninger Software | Visec-FIRE | automatic face |
| http://members.aol.com/vberninger/control1.html | | processing |
| IVS (Intelligent Verification Systems) | FaceKey | Unknown |
| Neurodynamics | Nvisage | Neural network |
| Cognitec/ | FaceVACS | feature analysis |
| Plettac Electronics | | |
| SSK-Virtual Image | Imager | “face vectors”, no |
| | | further details |
| VisionSphere | UnMask | “Holistic Feature |
| | | Coding” |

Table I

Copending application number (Attorney Docket 14873/002001) describes the use of three-dimensional information for biometric recognition. This technique forms an enrollment template that represents the shape of the face. The present invention recognizes that three dimensional techniques may be used to improve face recognition in two dimensions.

According to the present system, a three-dimensional image of known users is obtained as an enrollment template. This three-dimensional information is used to form two dimensional information that is used for two-dimensional face recognition using any of the above-discussed techniques, or any other two dimensional techniques, now known, or later discovered. The two-dimensional information which is formed from the three-dimensional information may be compensated for “misrecognition parameters” such as lighting and pose.

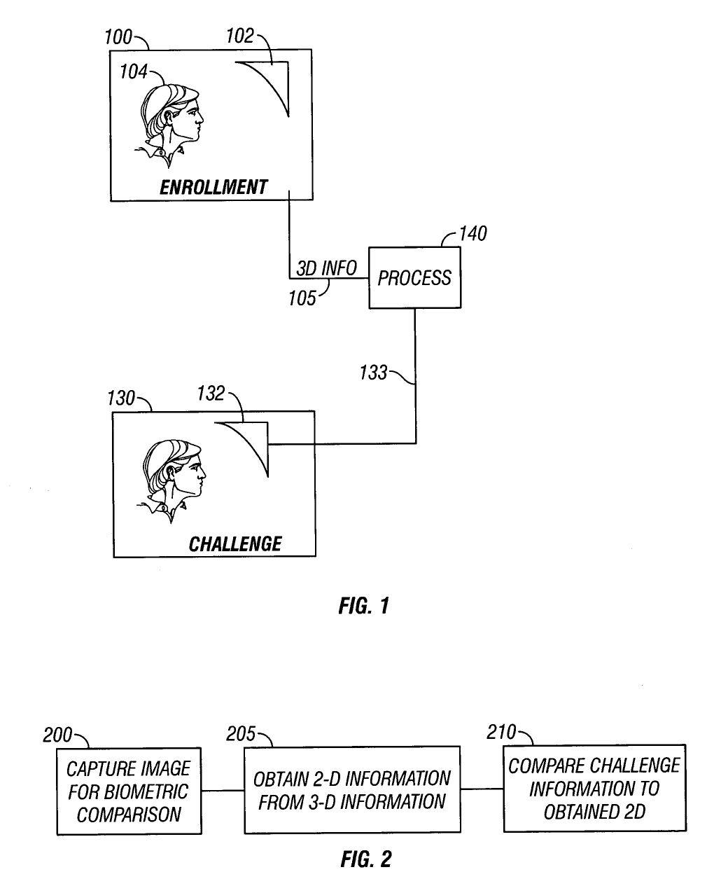

A block diagram of the overall system is shown in FIG. 1. An initial operation carries out enrollment shown as block 100. The enrollment system includes a camera 102 which acquires three dimensional information indicative of the user. This can be a stereo camera, or a three-dimensional laser system, or can just be a conventional camera. If the enrollment is done with a conventional camera, its output is later manually annotated using techniques known in the art, to provide three dimensional information from the two dimensional image.

The input may also be a set of images, automatically or manually processed to produce a 3D model, using tools from the photogrammetry field.

The input may also be a video stream, patent application “3D Model from a Single Camera” by Bastien Pesenti and Gerard Medioni, filed Mar. 3, 2002, application Ser. No. 10/236,020.

The 3D information is output as template 105.

A challenge is carried out in the challenge device 130. Note that the system may be used either for confirming identities, e.g., used as part of user identification confirmation, or for determining identities; for example comparing users who pass a certain point against a list of persons. One example of this latter system is looking for a face in a crowd, for terrorist or wanted person detection. In this environment, it will be assumed that the challenge station is a surveillance camera, however, it can also be other type cameras. Camera 132 produces an output indicative of a conventional two-dimensional picture.

Both the three-dimensional information 105 and the two-dimensional picture 133 are coupled to a processor 140 which carries out the face comparison. The processor may run the routine described in FIG. 2.

At 200, the challenge station 132 captures an image 133 for biometric comparison.

At 205, two-dimensional information is obtained from the three-dimensional enrollment information. This is done as described herein and preferably prepares compensated information. That two-dimensional information is then compared with the two-dimensional information obtained from the challenge. The comparison may be done using any commercially available face recognition system, either those described above with reference to table 1, or any other system.

An important part of this feature is that the two-dimensional information which is obtained can be compensated to correct for differences in conditions in the challenge picture. For example, the two-dimensional information may be used to correct for pose, lighting, hair style, aging, and other differences, which are collectively called misrecognition parameters.

Two different embodiments of correcting for the misrecognition parameters are disclosed.

A first embodiment operates to compute a set of images from the three-dimensional model. Each of the images of the set may be different in some way than other computed images. The images may be modified for characteristics including at least pose and lighting, and other misrecognition parameters.

In this embodiment, the 3D model is used to compute a set of pre-computed images which are used to populate the database used for the two-dimensional comparing. Since three dimensional information is obtained, this means that the system can visualize any three dimensional information from any different vantage point. Hence, this system can produce a two dimensional image from any of a plurality of different poses and angles can be obtained. Lighting can also be compensated.

Lighting compensation falls under the well researched field of rendering in Computer Graphics, and a number of techniques exist to perform this task. For instance, this is described in:

Computer Graphics: Principles and Practice in C (2nd Edition) by James D. Foley, Andries van Dam, Steven K. Feiner, John F. Hughes, Addison-Wesley Pub Co; 2nd edition (Aug. 4, 1995)

Specific compensation of this type for faces, is disclosed in:

“Acquiring the Reflectance Field of a Human Face”, Paul Debevec, Tim Hawkins, Chris Tchou, Haarm-Pieter Duiker, Westley Sarokin, and Mark Sagar, SIGGRAPH 2000 Conference Proceedings.

The database is populated with a number of different pre-computed pictures which are compensated for common misrecognition parameters, including pose and lighting. The images in the database may be pre-computed for multiple different poses, including the most common poses that a user may take especially when passing a camera. Again, the actual two-dimensional comparing can use the techniques disclosed above. The specific way that the two-dimensional images are formed can be automatic or manual. Users can manually set the parameters for the two-dimensional images, or an algorithm can be used which extracts specified poses which are commonly seen, or, these can be automatically obtained.

Another technique analyzes the two dimensional information obtained at 133, and estimates lighting and pose from that two-dimensional information. The estimated lighting and pose is then used to query the three-dimensional model to form a two-dimensional picture indicative of each three-dimensional model which most closely matches the pose and lighting.

A method to estimate both pose and lighting is described in “Identification by Fitting a 3D Morphable Model using Linear Shape and Texture Error Functions”

Sami Romdhani, Volker Blanz, and Thomas Vetter Computer Vision—ECCV 2002, May 2002, LNCS 2353, pp. 3-19.

Each of those formed two-dimensional pictures are compared against the challenge images, using a two-dimensional face comparing engine of the type described above.

This system may provide an effective bridge between the highly secure facial shape biometric used for access control, and the existing world of 2D surveillance cameras, facial image databases, and forensic analysis tools.

Although only a few embodiments have been disclosed in detail above, other modifications are possible. All such modifications are intended to be encompassed within the following claims.

What is claimed is:

1. A method comprising:
obtaining information about a known enrollee's face, said information being a type from which a number of different images can be formed;
forming information about images from said known information; and
using said information for a two-dimensional face comparison.

2. A method as in claim 1, wherein said known information comprises three-dimensional information indicative of a shape of a user's face.

3. A method as in claim 2, further comprising using a three-dimensional acquisition device to obtain said three-dimensional information.

4. A method as in claim 2, wherein said forming information comprises forming a plurality of two-dimensional images which are compensated for different amounts of misrecognition parameters.

5. A method as in claim 4, wherein said forming information comprises forming a plurality of images at different poses.

6. A method as in claim 4, wherein said forming information comprises forming a plurality of images at different lighting effects.

7. A method as in claim 6, wherein said forming information comprises forming a plurality of images at different poses and at said different lighting effects.

8. A method as in claim 2, wherein said forming comprises forming an image which is compensated for misrecognition parameters based on characteristics of a specific face recognition.

9. A method as in claim 1, further comprising obtaining a two-dimensional image of a face to be compared, and comparing said two-dimensional image using said information.

10. A method, comprising:
obtaining three-dimensional information indicative of a user's face; and
using said three-dimensional information to improve a two-dimensional face recognition.

11. A method as in claim 10, wherein said using comprises using said three-dimensional information to form a two-dimensional template indicative of a known user's face which is corrected for a misrecognition parameter, obtaining a two-dimensional image indicative of an unknown user's face; and comparing the two-dimensional template to the two-dimensional image.

12. A method as in claim 11, wherein said misrecognition parameter includes pose of the unknown user.

13. A method as in claim 11, wherein said misrecognition parameter includes lighting of the picture of the unknown user.

14. A method as in claim 11, wherein said obtaining comprises pre-computing a plurality of different two-dimensional images from the three-dimensional information, and populating a biometric database with said plurality of two-dimensional images.

15. A method as in claim 11, wherein said obtaining comprises determining a characteristic of the unknown user, and forming a two-dimensional image based on the determined characteristic.

16. A method as in claim 15, wherein said characteristic is automatically determined.

17. A method as in claim 15, wherein said characteristic is manually determined.

18. A face recognition system comprising:
a camera obtaining a two-dimensional image of an unknown person;
a memory, which stores three-dimensional information of at least one known person; and
a processor, forming two-dimensional information from the three-dimensional information and comparing the formed two-dimensional information with the image of the unknown person.

19. A system as in claim 18, wherein said processor pre-computes a plurality of items of two-dimensional information, and stores the pre-computed information in the memory.

20. A system as in claim 18, wherein the processor determines characteristics of said image of said unknown person, and produces a two-dimensional image from the three-dimensional information based on said characteristics.

21. A method, comprising:
using three dimensional information indicative of a user's face to form two dimensional information indicative of the user's face at a desired pose; and
using said two dimensional information in a biometric system.
